(19) United States
(12) Patent Application Publication
(10) Pub. No.: US 2009/0199640 A1
(43) Pub. Date: Aug. 13, 2009

(54) METHOD FOR ROLLING-ELEMENT BEARING DIAGNOSIS

(75) Inventor: Rupert Stitzinger, Ansbach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/302,391

(22) PCT Filed: May 31, 2007
(86) PCT No.: PCT/DE2007/000976

§ 371 Date: Jan. 22, 2009

(30) Foreign Application Priority Data
Jun. 1, 2006 (DE) 10 2006 025 626.3

(51) Int. Cl. G01M 13/04

(52) U.S. Cl. 73/593

(57) ABSTRACT

The invention relates to a method for the analysis of bearing damages by means of an envelope demodulation signal, at least one variable of the envelope demodulation signal that is characteristic of the occurrence of bearing damages being determined. The invention is characterized in that the characteristic variable is repeatedly determined during a plurality of predetermined intervals and these intervals are shorter than the intervals between external disturbances.

### FIELD OF THE INVENTION

The present invention relates to a method for analyzing damage to bearings, and in particular damage to bearings in roller bearings. The method according to the invention can be applied to a wide variety of types of roller bearings such as ball bearings, cylinder roller bearings, tapered roller bearings or self-aligning roller bearings. The roller bearings to be analyzed can be applied, for example, in electric motors, railroad wheel sets, transmissions, paper machine test benches and the like.

Due to wear, various types of damage can occur to roller bearings. An example of such damage is what is referred to as pitting, that is to say notches in the inner ring or outer ring or the roller bodies. In addition, surface damage can also occur. Since such pitting or damage can very quickly lead to rapid degrading of the roller bearing due to further use, there is a need to analyze such damage with a suitable measuring method. Various methods for analyzing states of a roller bearing are known from the prior art.

Such a diagnostic method is, for example, what is referred to as an envelope curve analysis. What is referred to as an envelope curve demodulation signal (ECD signal) is evaluated here in order to assess the state of the bearing. Such signals can be recorded, for example, with piezo-electric sensor devices which can be screwed or bonded onto the bearing housing or held on it by a magnetic fastener.

By using envelope curve analysis it is possible, for example, for periodic repetitions of shock, such as are generated by pitting in roller bearings, to be detected and monitored at an early stage so that the presence of damage can be inferred.

It is also known from the prior art to use the formation or evaluation of statistical characteristic variables, such as kurtosis (i.e. of the fourth moment) for diagnosing machines.

The Kurtosis is one of a larger number of commonly used statistical parameters for diagnosing roller bearings. The Kurtosis depends very heavily on the occurrence of individual disturbing influences. To be more precise, the occurrence of individual disturbances gives rise to a higher kurtosis level than a plurality of disturbances since the kurtosis of a signal with a single clear peak is very high. However, during the operation of roller bearings, external disturbances such as, for example, shocks and the like also occur, as a result of which in particular the kurtosis as a characteristic variable is considerably falsified.

For this reason, until now the kurtosis has been considered to be a characteristic variable which cannot be used, or can only be used to a limited degree, in diagnosing roller bearings.

Frequency analysis requires precise knowledge of the rotational speed.

In other diagnostic methods which are known from the prior art, a very high computing capacity is necessary.

The present invention is therefore based on the object of making available a diagnostic method which permits the state of the bearings to be assessed even when external disturbances occur, that is to say disturbances which are not related to damage to the bearings. This is intended to simplify diagnosis of damage on roller bearings in which vibrations other than those caused by damage to bearings are superimposed. In addition, a method is to be made available which indicates damage to a roller bearing or wheel set bearing without knowledge of the precise rotational speed.

This is achieved according to the invention by means of a method as claimed in claim 1.

Advantageous embodiments and developments are the subject matter of the subclaims.

In a method according to the invention for analyzing damage to bearings using an envelope curve demodulation (ECD) signal, at least one stochastic characteristic variable, characteristic of the occurrence of damage to bearings, is acquired from the envelope curve demodulation signal. According to the invention, the characteristic variable is repeatedly acquired at a plurality of predetermined time intervals, and these time intervals are shorter than the time interval between external disturbances.

Envelope curve demodulation is therefore performed first in the method according to the invention.

External disturbance variables are understood to be disturbances which are not caused by damage to bearings but rather, for example, by the operation of the roller bearing from the outside. As mentioned above, the kurtosis of a signal with a single clear peak is very high. However, these external shocks occur significantly less often than shocks which are caused by roller bodies rolling over pitted areas. The selection of a correspondingly shorter interval allows individual incorrect values to be virtually suppressed, in particular by averaging over a plurality of characteristic variables which are acquired in such intervals. However, instead of averaging, intervals with an extremely high kurtosis can also be separated out in a further method step.

In a further method according to the invention for analyzing damage to bearings using an envelope curve demodulation signal, at least one stochastic characteristic variable, characteristic of the occurrence of damage to bearings, of the envelope curve demodulation signal is determined. In this context, according to the invention the characteristic variable is repeatedly determined at a plurality of preset time intervals, and in a further method step, averaging over the plurality of characteristic variables determined at the different intervals is carried out. By virtue of this averaging it is possible, as mentioned above, for external disturbances which occur significantly less often than disturbances which are caused by damage to bearings to be suppressed better when taking into account kurtosis, in particular. This method also improves the way in which the kurtosis can be used as the characteristic variable which describes the state of the bearing.

Preferably longer time intervals than the roll-over time of the individual roller bodies, i.e. the roll-over time of the individual roller bodies over damage such as pitting which happens to be present, are preferably selected. This roll-over time of the individual roller bodies is obtained from the period of revolution of the individual roller bodies divided by the number of roller bodies. This roll-over time is considerably shorter than the average time interval between two external disturbances.

For recording of the damage to the bearings, the interval size is, as illustrated, greater than the respective roll-over time.

However, said external disturbances do not generally occur everywhere on a regular basis but on a statistical basis. For this reason, a time interval is preferably selected which is considerably shorter than the mean value of the time intervals between the individual external disturbances. Empirical values, which take into account, for example, the bearing used, its field of application and the like, can also be used for the basis of these mean values.

The time intervals are preferably shorter than half the time interval between the external disturbances, and in this context the mean value or anticipated value for this time interval can again be used as the basis for the time interval. The time intervals preferably exceed the roll-over time of the individual roller bodies by more than three times and preferably by more than four times. Such a selection of the time intervals permits particularly favorable evaluation of the envelope curve demodulation signal since at least three or four signal changes which are caused by damage to bearings occur within the interval.

The time intervals are preferably shorter than 100 times the roll-over time and preferably shorter than 40 times the roll-over time, and particularly preferably shorter than 30 times the roll-over time. In this way, the evaluation of the ECD signal can be improved since recording a plurality of roll-over times permits more precise evaluation of the damage to the bearings. As a result, a statement about the presence of damage and, if appropriate, also the severity of the damage can be made.

In a further method step, averaging is preferably carried out over a plurality of characteristic variables which are acquired in different intervals. This averaging makes it possible, as mentioned above, to suppress individual incorrect values, i.e. values which are not due to damage. These incorrect values can be due, for example, to external shocks. If such external shocks have a large influence on the overall signal when selecting of a correspondingly relatively long interval, as is known from the prior art, said shocks only affect individual intervals when short intervals are selected, and are therefore suppressed in the averaging. In a bearing without mechanical changes (for example changes due to pitting), this method supplies approximately the anticipated value for the kurtosis of three, that is to say the value which is to be expected for equally distributed noise. Outer ring pitting can lead to values up to 60 for the kurtosis.

The averaging is preferably selected from a group of types of averaging which contains arithmetic averaging, geometric averaging, integrals, combinations thereof and the like. Arithmetic averaging is preferably used.

In a further preferred method, the characteristic variable is the kurtosis. As mentioned at the outset, the kurtosis is one of the commonly used statistical parameters in said methods. However, instead of the kurtosis, it would also be possible, for example, to evaluate what is referred to as the crest factor. It would also be possible to determine what is referred to as the impulse factor or the shape factor.

In a further preferred method, at least two intervals are weighted differently. It is therefore possible, for example, for intervals in which particularly high characteristic variable values occur due to external shocks to be given a relatively weak weighting or, in an extreme case, to be weighted with a factor of zero, that is to say to be removed from the evaluation. In this way it is possible to suppress intervals in which external shocks have occurred, in order to improve the measurement result further in this way.

In a further preferred method, the length of the time intervals is variable. For example, the length of the time intervals can be adapted in a uniform fashion to the predefined rotational frequency of the roller bodies. However, the length of the time intervals does not have to be determined very precisely with the present invention, that is to say three stages of the revolution of the roller bodies such as “slow”, “medium” and “fast” may be sufficient for this determination of the time intervals.

In contrast to frequency analysis, the method according to the invention also does not require precise knowledge of the rotational speed since the evaluation through the formation of mean values is not sensitive to small fluctuations in rotational speed. A statement about the respective state of the bearings, i.e. in particular the presence of damage to the bearings such as outer ring or inner ring pitting, regardless of the respective current rotational speed can be made.

The selected time intervals are preferably essentially all of equal length. This simplifies the averaging over the individual intervals. However, it is also possible to select intervals with different lengths, and to select a relatively short interval length, in particular at locations of the signal which indicate the occurrence of first disturbances.

The present invention is also aimed at a computer program for carrying out a method of the type described above.

Further advantageous embodiments emerge from the appended drawings, in which:

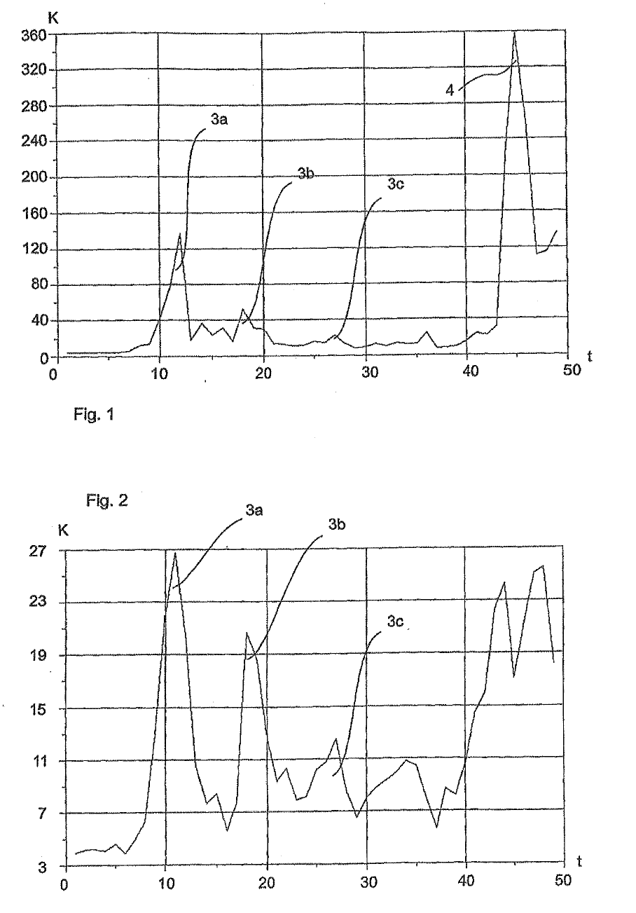

FIG. 1 shows a profile of the kurtosis with an interval size of 4 seconds; and

FIG. 2 shows a profile of the kurtosis with an interval size of 0.2 seconds.

FIGS. 1 and 2 show the kurtosis K which has been acquired over a time period of 50 seconds from the ECD signal. Here, both FIG. 1 and FIG. 2 are based on the same measurement data or raw data.

In the case of FIG. 1, time intervals of 4 seconds, and in FIG. 2 time intervals of 0.2 seconds, respectively, have been used as the basis. In both illustrations, one measured value has been output per second, with (sliding) arithmetic average values having been formed in each case.

The reference symbols 3a, 3b and 3c characterize the kurtosis at locations at which external disturbances respectively occur. It is apparent that in the case of FIG. 1 maximum values of the kurtosis of 27 occur in this range. In FIG. 2, i.e. the illustration which shows the use of longer time intervals of 4 seconds, values of the kurtosis occur in the region of 140. The very high peak value 4 both in FIG. 1 and in FIG. 2 is due to measurement artifacts which can occur at very low rotational speeds of the roller bearings. Reasonable values can no longer be output at these very slow rotations.

The time interval between the peaks which are caused by external disturbances or shocks is, as explained at the beginning, in the region of approximately 4 seconds. As a result of the selection of 4 seconds as the interval length, as shown in FIG. 2, such peaks cannot be satisfactorily suppressed and very high values up to 140 are therefore yielded for the kurtosis. In contrast, the selection of short intervals of, in this case, 0.2 seconds, means that the values for the kurtosis can be reduced by averaging over a plurality of such values, in the following case averaging is respectively carried out over 50 values. However, at the same time, the changes in the kurtosis which are caused by damage to the bearing are recorded since the time interval between said changes is significantly below 0.2 seconds. In the case of a roll-over frequency of 70 Hz, a time interval of 0.014 seconds would result between the shocks caused by damage. Using a time interval of 0.2 seconds, it would therefore be possible to record 14 shocks per interval.

For this reason, values of 0.2 seconds for the interval lengths are still large enough to permit a plurality of rolling over processes of individual roller bodies over damage to be recorded.

From FIGS. 1 and 2 it becomes very clear that the inventive selection of short intervals and the corresponding formation of mean values also allows the measured signals to be evaluated particularly favorably with respect to the kurtosis.

All the features disclosed in the application documents are claimed as essential to the invention insofar as they are novel over the prior art, either individually or in combination.

### LIST OF REFERENCE SYMBOLS

K Kurtosis

t Time

3a, 3b, 3c Kurtosis K at locations with external disturbance

4 Peak value

1. A method for analyzing damage to bearings using an envelope curve demodulation signal, having at least one stochastic characteristic variable, characteristic of the occurrence of damage to bearings, of the envelope curve demodulation signal is determined, wherein the characteristic variable is repeatedly determined at a plurality of present time intervals, and the time intervals are shorter than the time interval between external disturbances.

2. The method as claimed in claim 1, wherein, in a further method step, averaging over a plurality of characteristic variables acquired at different intervals is carried out.

3. The method as claimed in claim 1, wherein the time intervals are longer than roll-over time of individual roller bodies.

4. The method as claimed in claim 3, wherein the time intervals exceed the roll-over time of the individual roller bodies by more than three times.

5. The method as claimed in claim 3, wherein the time intervals are shorter than 100 times the roll-over time.

6. The method as claimed in claim 2, wherein the averaging is selected from a group of types of averaging which contains arithmetic averaging, geometric averaging, integrals, and combinations thereof.

7. The method as claimed in claim 1, wherein the characteristic variable is a kurtosis.

8. The method as claimed in claim 1, wherein at least two intervals are weighted differently.

9. The method as claimed in claim 1, wherein length of the time intervals are variable.

10. The method as claimed in claim 3, wherein the time intervals exceed the roll-over time of the individual roller bodies by more than four times.

11. The method as claimed in claim 3, wherein the time intervals are shorter than 40 times the roll-over time.

12. The method as claimed in claim 3, wherein the time intervals are shorter than 30 times the roll-over time.
